(19) United States
(12) Patent Application Publication
(10) Pub. No.: US 2013/0242576 A1
(43) Pub. Date: Sep. 19, 2013

(54) LIGHT EMITTING APPARATUS

(71) Applicants: Sungjin KIM, Seoul (KR); ByungKwon SONG, Bucheon-si (KR)

(72) Inventors: Sungjin KIM, Seoul (KR); ByungKwon SONG, Bucheon-si (KR)

(73) Assignee: SAMSUNG LED CO., LTD., Yongin-city (KR)

(21) Appl. No.: 13/419,043

(22) Filed: Mar. 13, 2012

(51) Int. Cl. F21V 29/00

(52) U.S. Cl. 362/382

(57) ABSTRACT

Provided is a light emitting apparatus including a body unit, a control unit configured to control a light emitting diode (LED), a heat emitting unit configured to emit heat of the LED, and an assembly unit configured to mutually connect the control unit and the heat emitting unit to the body unit. According to the foregoing structure, the body unit, the control unit, and the heat emitting unit may be connected through a single assembly process, thereby improving assembly efficiency.

### BACKGROUND

1. Field of the Invention

The present invention relates to a light emitting apparatus that may be easy to assemble, and more particularly, to a light emitting apparatus that may mutually connect a plurality of units through a single assembly process.

2. Description of the Related Art

Recent development of semiconductor technology is increasing use and application of a high-performance light emitting diode (LED) in various fields. For example, the LED is applied to a backlight unit of a display device, and lighting systems such as incandescent bulbs, fluorescent lamps, and road lamps.

The LED achieves a long lifespan and expends a low amount of power, thereby reducing costs for maintenance and repair. However, since deterioration of the LED may be caused by a thermal stress, the LED is provided with a heat emitting means such as a heat sink. Accordingly, there is a desire for research into improving efficiency in assembly of a plurality of parts including a heat emitting means in a light emitting apparatus employing the LED.

### SUMMARY

Provided is a light emitting apparatus that may improve assembly efficiency of a plurality of units, and may ensure secure safety in use of the light emitting apparatus.

An aspect of the present invention provides a light emitting apparatus including a body unit, a control unit configured to control a light emitting diode (LED), a heat emitting unit configured to emit heat of the LED, and an assembly unit configured to mutually connect the control unit and the heat emitting unit to the body unit.

The assembly unit may include a plurality of assembly members fixed to the body unit, jointly through the control unit and the heat emitting unit, and one of the plurality of assembly members may be configured to apply an electric current mutually to the control unit and the heat emitting unit.

The assembly unit may include at least one first assembly member configured to fix the control unit and the heat emitting unit to the body unit, in a state in which an electric current may be not applied mutually to the control unit and the heat emitting unit, and at least one second assembly member configured to connect the control unit and the heat emitting unit to the body unit, in a state in which an electric current may be applied mutually to the control unit and the heat emitting unit.

The assembly unit may include at least one first assembly member connected to the body unit through at least one first assembly hole and at least one second assembly hole which may be formed to each of the control unit and the heat emitting unit to be interconnected with each other, and out of contact with the at least one first assembly hole and the at least one second assembly hole, and at least one second assembly member connected to the body unit through at least one third assembly hole and at least one fourth assembly hole which may be formed to each of the control unit and the heat emitting unit to be interconnected with each other, and in contact with a partial area of the at least one fourth assembly hole to apply an electric current mutually to the control unit and the heat emitting unit.

The assembly unit may include at least one first assembly member connected to at least one first assembly recess formed in the body unit, through at least one first assembly hole and at least one second assembly hole which may be formed to each of the control unit and the heat emitting unit to be interconnected with each other, and out of contact with the at least one first assembly hole and the at least one second assembly hole, and at least one second assembly member connected to at least one second assembly recess formed in the body unit, through at least one third assembly hole and at least one fourth assembly hole which may be formed to each of the control unit and the heat emitting unit to be interconnected with each other, and in contact with a partial area of the at least one fourth assembly hole to apply an electric current mutually to the control unit and the heat emitting unit. Here, the at least one fourth assembly hole may include an inclined surface that may be inclined in a direction in which the at least one fourth assembly hole may be in contact with the at least one second assembly member, and a contact surface, extending from the inclined surface, to be in contact with the at least one second assembly member.

The assembly unit may include at least one first assembly member connected to the body unit through at least one first assembly hole and at least one second assembly hole which may be formed to each of the control unit and the heat emitting unit to be interconnected with each other, and out of contact with the at least one first assembly hole and the at least one second assembly hole, and at least one second assembly member connected to the body unit through at least one third assembly hole and at least one fourth assembly hole which may be formed to each of the control unit and the heat emitting unit to be interconnected with each other, and in contact with a partial area of the at least one fourth assembly hole to apply an electric current mutually to the control unit and the heat emitting unit. The at least one fourth hole may include a curved surface that may be curved towards the at least one second assembly member or a projection that may protrude towards the at least one second assembly member, to be in contact with the at least one second assembly member

Another aspect of the present invention also provides a light emitting apparatus including a body unit, a control unit connected to the body unit to control an LED, a heat emitting unit connected to the body unit to emit heat generated by the LED, and an assembly unit configured to mutually connect the control unit and the heat emitting unit to the body unit, and to ground the control unit.

The assembly unit may include a plurality of assembly members fixed to the body unit, jointly through the control unit and the heat emitting unit, and one of the plurality of assembly members may apply an electric current mutually to the control unit and the heat emitting unit.

The assembly unit may include at least one first assembly member connected to the body unit, jointly through the control unit and the heat emitting unit, and out of contact with the control unit and the heat emitting unit, and at least one second assembly member connected to the body unit, jointly through the control unit and the heat emitting unit, in a state in which an electric current may be applied mutually to the control unit and the heat emitting unit.

The assembly unit may include a first assembly member connected to the body unit through at least one first assembly hole and at least one second assembly hole which may be formed to each of the control unit and the heat emitting unit to be interconnected with each other, and out of contact with the at least one first assembly hole and the at least one second assembly hole, and a second assembly member connected to the body unit through at least one third assembly hole and at least one fourth assembly hole which may be formed to each of the control unit and the heat emitting unit to be interconnected with each other, and in contact with a partial area of the at least one fourth assembly hole to apply an electric current mutually to the control unit and the heat emitting unit. Here, the at least one fourth assembly hole may include at least one of an inclined surface that may be inclined towards the second assembly member, a curved surface that may be curved towards the second assembly member, or a projection that may protrude towards the second assembly member.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is an exploded perspective view illustrating a light emitting apparatus according to an embodiment of the present invention;

FIG. 2 is a cross-sectional view illustrating a state in which the light emitting apparatus illustrated in FIG. 1 may be assembled;

FIG. 3 is a cross-sectional view illustrating a variation on a fourth assembly hole illustrated in FIG. 2; and

FIG. 4 is a cross-sectional view illustrating another variation on the fourth assembly hole illustrated in FIG. 2.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

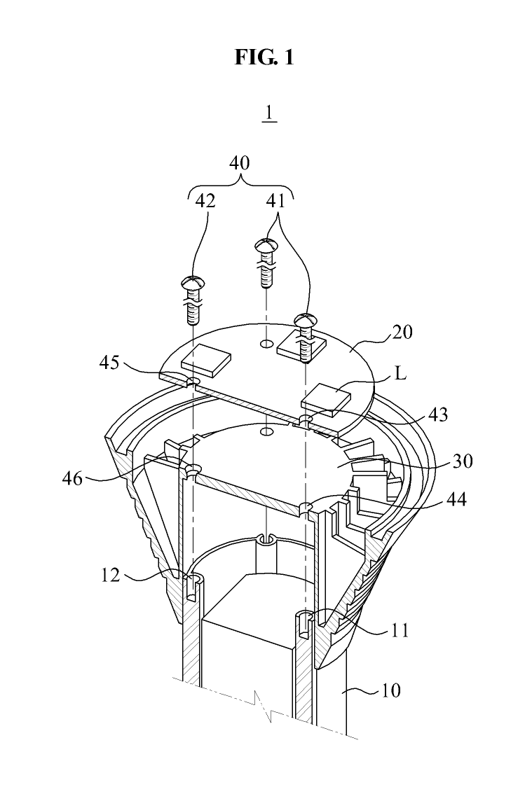

FIG. 1 is an exploded perspective view illustrating a light emitting apparatus 1 according to an embodiment of the present invention.

Referring to FIG. 1, the light emitting apparatus 1 may include a body unit 10, a control unit 20, a heat emitting unit 30, and an assembly unit 40.

Herein, the light emitting apparatus 1 will be explained as a lamp employing a light emitting diode (LED) L, however, it is not limited thereto.

The body unit 10 may correspond to a body of the light emitting apparatus 1 that may support predetermined built-in parts. The body unit 10 may be formed of a material such as plastic that is easy to mold and process, however, the material is not limited thereto.

The control unit 20 may be connected to the body unit 10 to control the LED L. The control unit 20 may correspond to a metal cored printed circuit board (MCPCB) which may correspond to an insulating substrate and to which the LED L may be mounted. The control unit 20 may be installed at a front side of the body unit 10, that is, in a direction in which light may be radiated.

The heat emitting unit 30 may be connected to the body unit 10 to emit heat generated by the LED L. That is, the heat emitting unit 30 may prevent problems, such as damage and a decrease in safety, due to the body unit 10 being heated by the heat generated by the LED L, and may also prevent other parts supported by the body unit 10 from being interfered with by the heat.

Various heat emitting means may be employed for the heat emitting unit 30, and in the present embodiments, the heat emitting unit 30 may correspond to a heat sink.

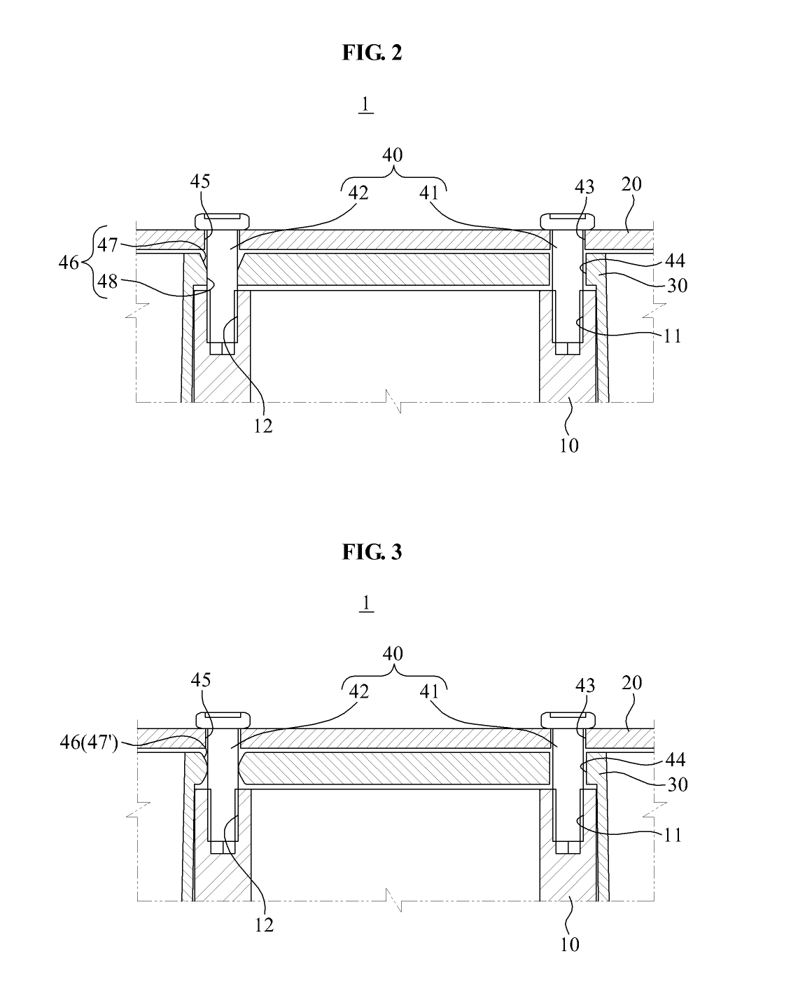

The assembly unit 40 may mutually connect the control unit 20 and the heat emitting unit 30 to the body unit 10. In particular, the assembly unit 40 may sequentially connect the heat emitting unit 30 and the control unit 20 in the front side of the body unit 10. The assembly unit 40 may include a first assembly member 41 and a second assembly member 42. The first assembly member 41 may be connected to a first assembly recess 11 of the body unit 10 through a first assembly hole 43 and a second assembly hole 44 that may be formed to the control unit 20 and the heat emitting unit 30 to be interconnected with each other, and out of contact with the heat emitting unit 30, thereby connecting the control unit 20 and the heat emitting unit 30 to the body unit 10. In this instance, as shown in FIG. 2, the first assembly member 41 may be connected to the body unit 10, in a state of being out of the contact with the first assembly hole 43 and the second assembly hole 44. Accordingly, the first assembly member 41 may connect the control unit 20 and the heat emitting unit 30, which may have different material properties with respect to the body unit 10, to the body unit 10 through a single assembly process. As to the first assembly member 41, at least one first assembly member 41 may be provided, and in the present embodiments, two first assembly members 41 may be provided as shown in FIG. 1.

One end of the first assembly member 41 may be in contact with the control unit 20 that may be laminated on the uppermost portion, and the other end of the first assembly member 41 may correspond to a screw to be connected to the body unit 10 through the control unit 20 and the heat emitting unit 30, sequentially.

The second assembly member 42 may connect the control unit 20 and the heat emitting unit 30 to the body unit, in a state of being in contact with the heat emitting unit 30. As to the second assembly member 42, at least one second assembly member 42 may be provided, and in the present embodiments, a single second assembly member 42 may be provided as shown in FIG. 1. Similar to the first assembly member 41, one end of the second assembly member 42 may be in contact with the control unit 20 that may be laminated on the uppermost portion, and the other end of the second assembly member 42 may correspond to a screw to be connected to the body unit 10 through the control unit 20 and the heat emitting unit 30, sequentially.

The second assembly member 42 may be connected to a second assembly recess 12 formed to the body unit 10, through at least one third assembly hole 45 and at least one fourth assembly hole 46 that may be formed on each of the control unit 20 and the heat emitting unit 30. In this instance, as shown in FIG. 2, the second assembly member 42 may be connected to the body unit 10 in a state of being in contact with the fourth assembly hole 46 formed on the heat emitting unit 30.

As shown in FIG. 2, the fourth assembly hole 46 may include an inclined surface 47 formed on an entry side of the fourth assembly hole 46, towards the second assembly member 42, based on an assembly direction of the second assembly member 42 entering the fourth assembly hole 46 after penetrating through the third assembly hole 45. Also, the fourth assembly hole 46 may include a contact surface 48, extending from the inclined surface 47, to be in contact with the second assembly member 42. When the second assembly member 42 is connected to the second assembly recess 12 in a state of being in contact with at least a partial area of the fourth assemble hole 46, by the inclined surface 47 of the fourth assembly hole 46, friction occurring when the second assembly member 42 is in contact with the heat emitting unit 30 may be reduced. Here, an angle of inclination of the inclined surface 47 of the fourth assembly hole 46 and a surface area of the contact surface 48 are not limited to examples illustrated in the foregoing.

As aforementioned, when the second assembly member 42 is in contact with the heat emitting unit 30 through the fourth assembly hole 46, an electric current may be applied mutually to the control unit 20 and the heat emitting unit, in so doing the control unit 20 may be grounded.

A shape of the fourth assembly hole 46, through which the second assembly member 42 may penetrate in a state of being in contact with the fourth assembly hole 46, is not limited to the shape including the inclined surface 47 and the contact surface 48. For example, as shown in FIG. 3, the fourth assembly hole 46 may have a shape including a curved surface 47′ towards the second assembly member 42. Accordingly, a variation in which the second assembly member 42 may be in contact with the fourth assembly hole 46 while occurring low friction may be possible.

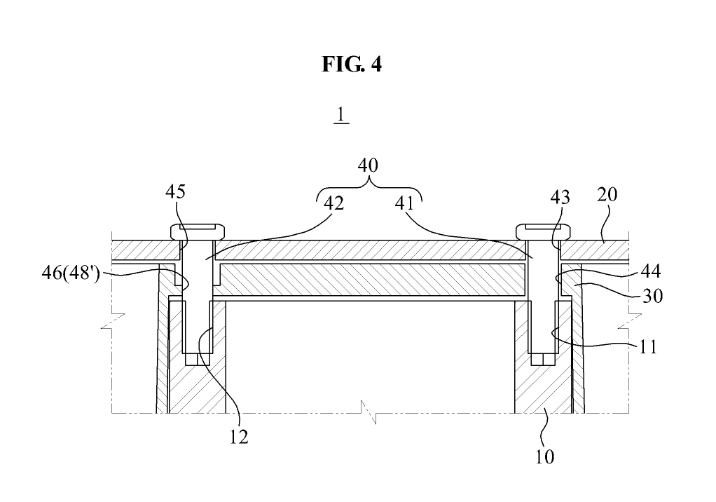

Also, as shown in FIG. 4, another variation in which the fourth assembly hole 46 may include a projection 48′ protruding towards the second assembly member 42, instead of the inclined surface 47, may be possible. In this instance, the protruding projection 48′ may be formed to protrude at an exit side of the fourth assembly hole 46, based on an assembly direction of the second assembly member 42. Here, a cross section of the protruding projection 48′ may be “L”-shaped. In this instance, the projection 48′ of the fourth assembly hole 46 may be in contact with the second assembly member 42, in so doing an electric current may be applied mutually.

Although not shown in detail, the fourth assembly hole 46 may be formed in various other shapes so that friction occurring between the fourth assembly hole 46 and the second assembly member 42 may be reduced, and an electric current may be applied mutually to the control unit 20 and the heat emitting unit 30, as well. The various other shapes may include, for example, a convex shape, and a peak shape. That is, a diversity of variations in which only a partial area of an inner surface of the fourth assembly hole 46 may be in contact with the second assembly member 42 may be possible.

An assembly operation of the light emitting apparatus 1 structured as described in the foregoing will be described with reference to FIG. 1.

As shown in FIG. 1, the heat emitting unit 30 and the control unit 20 may be positioned to be laminated sequentially on an upper portion of the body unit 10, and the first assembly member 41 may be connected to the first assembly recess 11 through the first assembly hole 43 and the second assembly hole 44. In addition, the second assembly member 42 may be connected to the second assembly recess 12 through the third assembly hole 45 and the fourth assembly hole 46, in so doing the heat emitting unit 30 and the control unit 20 may be connected and fixed to the body unit 10.

In this instance, the second assembly member 42 may be connected to the body unit 10 in a state of being in contact with the contact surface 48 of the fourth assembly hole 46. Accordingly, an electric current may be applied mutually to the control unit 20 and the heat emitting unit 30, in so doing the control unit 20 may be grounded.

According to the foregoing structure, the body unit, the control unit, and the heat emitting unit may be connected through a single assembly process, thereby improving assembly efficiency.

Also, improvement of assembly efficiency may lead to improvement of economical efficiency, as well as maintenance and repair.

Also, at least one of the plurality of assembly members may be in contact with the heat emitting unit to apply an electric current mutually to the control unit and the heat emitting unit, and the control unit may be grounded, thereby improving safety.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A light emitting apparatus, comprising:
a body unit;
a control unit configured to control a light emitting diode (LED);
a heat emitting unit configured to emit heat of the LED; and
an assembly unit configured to mutually connect the control unit and the heat emitting unit to the body unit.

2. The apparatus of claim 1, wherein
the assembly unit comprises a plurality of assembly members fixed to the body unit, jointly through the control unit and the heat emitting unit, and
one of the plurality of assembly members is configured to apply an electric current mutually to the control unit and the heat emitting unit.

3. The apparatus of claim 1, wherein the assembly unit comprises:
at least one first assembly member configured to fix the control unit and the heat emitting unit to the body unit, in a state in which an electric current is not applied mutually to the control unit and the heat emitting unit; and
at least one second assembly member configured to connect the control unit and the heat emitting unit to the body unit, in a state in which an electric current is applied mutually to the control unit and the heat emitting unit.

4. The apparatus of claim 1, wherein the assembly unit comprises:
at least one first assembly member connected to the body unit through at least one first assembly hole and at least one second assembly hole which are formed to each of the control unit and the heat emitting unit to be interconnected with each other, and out of contact with the at least one first assembly hole and the at least one second assembly hole; and
at least one second assembly member connected to the body unit through at least one third assembly hole and at least one fourth assembly hole which are formed to each of the control unit and the heat emitting unit to be interconnected with each other, and in contact with a partial area of the at least one fourth assembly hole to apply an electric current mutually to the control unit and the heat emitting unit.

5. The apparatus of claim 1, wherein
the assembly unit comprises:
at least one first assembly member connected to at least one first assembly recess formed in the body unit, through at least one first assembly hole and at least one second assembly hole which are formed to each of the control unit and the heat emitting unit to be interconnected with each other, and out of contact with the at least one first assembly hole and the at least one second assembly hole; and
at least one second assembly member connected to at least one second assembly recess formed in the body unit, through at least one third assembly hole and at least one fourth assembly hole which are formed to each of the control unit and the heat emitting unit to be interconnected with each other, and in contact with a partial area of the at least one fourth assembly hole to apply an electric current mutually to the control unit and the heat emitting unit, and
the at least one fourth assembly hole comprises an inclined surface that is inclined in a direction in which the at least one fourth assembly hole is in contact with the at least one second assembly member, and a contact surface, extending from the inclined surface, to be in contact with the at least one second assembly member.

6. The apparatus of claim 1, wherein the assembly unit comprises:
at least one first assembly member connected to the body unit through at least one first assembly hole and at least one second assembly hole which are formed to each of the control unit and the heat emitting unit to be interconnected with each other, and out of contact with the at least one first assembly hole and the at least one second assembly hole; and
at least one second assembly member connected to the body unit through at least one third assembly hole and at least one fourth assembly hole which are formed to each of the control unit and the heat emitting unit to be interconnected with each other, and in contact with a partial area of the at least one fourth assembly hole to apply an electric current mutually to the control unit and the heat emitting unit, and
the at least one fourth hole comprises a curved surface that is curved towards the at least one second assembly member or a projection that protrudes towards the at least one second assembly member, to be in contact with the at least one second assembly member.

7. A light emitting apparatus, comprising:
a body unit;
a control unit connected to the body unit to control a light emitting diode (LED);
a heat emitting unit connected to the body unit to emit heat generated by the LED; and
an assembly unit configured to mutually connect the control unit and the heat emitting unit to the body unit, and to ground the control unit.

8. The apparatus of claim 7, wherein
the assembly unit comprises a plurality of assembly members fixed to the body unit, jointly through the control unit and the heat emitting unit, and
one of the plurality of assembly members applies an electric current mutually to the control unit and the heat emitting unit.

9. The apparatus of claim 7, wherein the assembly unit comprises:
at least one first assembly member connected to the body unit, jointly through the control unit and the heat emitting unit, and out of contact with the control unit and the heat emitting unit; and
at least one second assembly member connected to the body unit, jointly through the control unit and the heat emitting unit, in a state in which an electric current is applied mutually to the control unit and the heat emitting unit.

10. The apparatus of claim 7, wherein the assembly unit comprises:
a first assembly member connected to the body unit through at least one first assembly hole and at least one second assembly hole which are formed to each of the control unit and the heat emitting unit to be interconnected with each other, and out of contact with the at least one first assembly hole and the at least one second assembly hole; and
a second assembly member connected to the body unit through at least one third assembly hole and at least one fourth assembly hole which are formed to each of the control unit and the heat emitting unit to be interconnected with each other, and in contact with a partial area of the at least one fourth assembly hole to apply an electric current mutually to the control unit and the heat emitting unit, and
the at least one fourth assembly hole comprises at least one of an inclined surface that is inclined towards the second assembly member, a curved surface that is curved towards the at second assembly member, or a projection that protrudes towards the second assembly member.
